(19) United States
(12) Patent Application Publication
(10) Pub. No.: US 2009/0173751 A1
(43) Pub. Date: Jul. 9, 2009

(54) Check valve and a split-body fluid device having such a check valve

(75) Inventors: Keith Laidler, West Midlands (GB); Timothy Rodd, Hants (GB)

Correspondence Address: PEARSON & PEARSON, LLP, 10 GEORGE STREET, LOWELL, MA, 01852, US

(73) Assignee: Incro Limited, Stourbridge (GB)

(21) Appl. No.: 11/920,946

(22) PCT Filed: May 26, 2006
(86) PCT No.: PCT/GB2006/001963

§ 371 Date: Dec. 29, 2008

(30) Foreign Application Priority Data
May 26, 2005 (GB) 0510707.3
Jun. 16, 2005 (GB) 0512237.9

(51) Int. Cl. B65D 37/00; B67D 5/40

(52) U.S. Cl. 222/207; 222/383.1

(57) ABSTRACT

A valve (338) has a body (312, 314) a fluid inlet (378), a fluid outlet (399) and a bore (362) defined in the body and which forms at least part of a fluid passage from the inlet to the outlet. The valve also has a movable valve member (366) with a resiliency flexible diaphragm portion (370) and a valve bore closure portion (374) mounted to the diaphragm for movement therewith. The flexible diaphragm portion (370) is movable in a valve opening direction from an initial resiliently biased configuration (as shown), in which the valve bore closure portion (374) closes the bore (362), to a valve open configuration in which the valve bore closure portion (374) does not close the bore and a fluid flow path through the bore from the inlet to the outlet is established. The valve is configured such that the diaphragm (370) is able to move in the valve opening direction from its initial resiliently biased configuration towards its valve open configuration by a limited amount during which range of movement the valve bore (362) is closed by the valve bore closure portion (374). The valve is particular suited for use as a pre-compression outlet valve for a pump-action dispenser (310).

This invention relates to a check valve and, more particularly but not exclusively, to a check valve for controlling the movement of a fluid in a split-body fluid device such as a pump-action dispenser device. The invention also relates to a split-body fluid device having such a check valve.

Pump-action dispenser devices provide a convenient means by which fluids, usually liquids such as liquor, can be dispensed from non-pressurised containers. Conventional pump-action dispenser devices comprise an internal chamber provided with an inlet and an outlet. The chamber can be compressed to dispense a fluid present therein through the outlet of the device. The chamber can then be allowed to re-expand to enable more fluid to be drawn into the chamber through the inlet. One-way check valves are disposed at the inlet and outlet to ensure that fluid can only be dispensed through the outlet when the chamber is compressed and drawn in through the inlet when the chamber is allowed to re-expand. The valves are typically pressure dependent valves which only open when a certain minimum pressure differential exists across the valve or where a fluid acting on one side of the valve is at a predetermined pressure. For instance, the outlet valve is typically a one-way check valve that only opens to permit fluid from the chamber to be dispensed through the outlet when the pressure of the fluid in the chamber exceeds a predetermined minimum threshold pressure. At all other times, the outlet valve is closed thereby preventing any fluid flow into or out of the chamber through the outlet. This type of valve is sometimes referred to as a pre-compression valve. Likewise, the inlet valve is typically adapted to only open and permit fluid to flow into the chamber when the pressure within the chamber falls below a predetermined minimum threshold pressure (as is the case when the chamber is allowed to re-expand). Again, this valve will be closed at all other times.

Controlling the pressure of the fluid exiting the pump chamber plays an important role in ensuring that the liquid product is dispensed correctly. In certain applications, the product is dispensed in the form of an atomised spray. To achieve an atomised spray, the product must pass through the nozzle with a minimum velocity. Thus, the outlet valve should open only when the product in the pump chamber has reached a minimum operating pressure at which it will pass through the nozzle with sufficient velocity that it is atomised. Ideally, the valve should open quickly when the product reaches the required operating pressure, deliver a set volume of fluid in a very short amount of time, usually 0.4 to 0.7 seconds, and close quickly at the end of the delivery cycle to prevent spluttering. The requirements for the valve are thus dependent on the operating pressure and the volume of fluid that must be discharged as well as the characteristics of the fluid itself. Even for dispensers that are not required to produce an atomised spray, control of the outlet valve is important to ensure the required volume of fluid product is dispensed cleanly and accurately.

Various types of valve have been used in pump-action dispenser devices. These include ball type valves in which a ball bearing is spring loaded into contact with a valve seat. The valve opens once the pressure of the fluid acting on the ball is sufficient to overcome the bias force of the spring and lift the ball from the valve seat. Ball type valves work well but they comprise a number of separate components and so are relatively expensive to manufacture. Ball type valves are often provided in the form of a separate valve unit that must be assembled to the dispenser device. This adds to the time and cost of manufacturing the dispenser device.

It is also known to provide flap valves in which a flap is resiliently biased to cover the inlet or outlet, the flap being moved away from the inlet or outlet to allow fluid to pass through when the pressure of the fluid acting on the flap is sufficient to overcome the resilient bias force. Flap type valves are simple in design and relatively cheap to manufacture. They also have the advantage that they can be produced integrally with the body of a dispenser device when this is manufactured from plastics as an injection moulding. However, flap type valves are not always reliable and it can be difficult to ensure they seal properly when the valve is closed. A further problem is that the resilient bias force tending to close the flap can vary over time affecting the performance of the dispenser device.

A further type of valve used in pump-action devices comprises a male valve member in the form of a projection that is received in female valve member such as a hole or recess. The projection is mounted to a resiliently flexible member that biases the projection into engagement with the side walls of the hole or recess to close the valve. The valve is opened when the pressure of the fluid acting on the projection, or between the projection and the surface of the hole or recess, is sufficient to overcome the bias force of the resilient member and move the projection away from the surface of the hole or recess to establish a flow path through the valve. This type of valve has similar advantages to the flap type valve but tends to produce a more reliable seal. However, this type of valve also suffers from similar disadvantages to those of the flap type valve and it can be difficult to produce a valve that will reliably open at the required operating pressure, particularly using high volume production techniques.

In all the prior art valves, a valve member makes sealing contact with a valve seat and the arrangement is such that any movement of the valve member away from the valve seat in response to an increase in the pressure of the fluid acting on the valve member cases the valve to open, at least partially. It is therefore necessary to ensure that the valve member is not moved away from the valve seat until the pressure of the fluid is at the required pressure and that the valve is then opened as quickly as possible. This is difficult to achieve with known valve arrangements.

It is an objective of the present invention to provide a valve capable of operating as a one-way, pre-compression valve in a pump-action dispenser and which will reliably and repeatably open when the fluid is at the required operating pressure and yet which is relatively simple in design and which can be manufactured at a low cost suitable for high volume production.

It is a further objective of the invention to provide a valve capable of operating as a one-way, pre-compression valve in a pump-action dispenser that can be configured to operate effectively over a range of operating pressures and discharge volumes.

It is a yet further objective of the invention to provide a pump-action dispenser incorporating such a valve.

In accordance with a first aspect of the invention, there is provided a valve having a body, a fluid inlet, a fluid outlet and a bore defined in the body and which forms at least part of a fluid passage from the inlet to the outlet, the valve further comprising a movable valve member having a resiliently flexible diaphragm portion and a valve bore closure portion mounted to the diaphragm for movement therewith, the flexible diaphragm portion being movable in a valve opening direction from an initial resiliently biased configuration, in which the valve bore closure portion closes the bore to prevent fluid flowing through the bore from the inlet to the outlet, to a valve open configuration in which the valve bore closure portion does not close the bore and a fluid flow path through the bore from the inlet to the outlet is established, characterised in that valve is configured such that the diaphragm is able to move in the valve opening direction from its initial resiliently biased configuration towards its valve open configuration by a limited amount during which range of movement the valve bore is closed by the valve bore closure portion.

The valve bore closure member may comprise a plunger having seal means for engaging with a sealing region of the inner surface of the bore to form a seal preventing fluid from flowing through the bore from the inlet to the outlet when the diaphragm is in its initial configuration

The plunger may have a main body portion with a diameter smaller than that of the valve bore and the seal means may be mounted to the main body portion.

Alternatively, the plunger may have a main body portion with a diameter smaller than that of the valve bore and the seal means may comprise an enlarged diameter portion the plunger.

The sealing region of the surface of the bore may extend over a predetermined length of the bore and the valve may be configured so that plunger moves along the bore with the seal means in engagement with the sealing region as the diaphragm moves by said limited amount in the valve opening direction.

Movement of the diaphragm beyond said limited amount may move the seal means off the sealing region of the surface of the bore to open a flow path through the bore from the inlet to the outlet.

The valve may be configured so that the plunger seal is withdrawn from the bore when the diaphragm moves in the valve opening direction beyond said limited amount to open the flow path.

The bore may have an enlarged diameter portion, and the valve may be configured so that movement of the diaphragm beyond said limited amount in the valve opening direction moves the plunger seal means into the enlarged diameter portion to open the flow path.

There may be at least one groove or slot in the surface of bore at one end thereof adjacent the sealing region, an outermost end of the at least one groove or slot being in fluid connection with one of the valve inlet and the valve outlet, and the valve may be configured so that movement of the diaphragm beyond said limited amount in the valve opening direction moves the plunger seal means off the sealing region and over the at least one groove or slot to open a fluid flow path through the valve from the inlet to the outlet.

In one embodiment, one of a fluid inlet passage and a fluid outlet passage opens into the valve bore at a position part way along the valve bore adjacent the sealing region, the arrangement being such that movement of the diaphragm beyond said limited amount in the valve opening direction moves the plunger seal means over the opening of said one of the inlet fluid passage and the fluid outlet passage to open the fluid flow path across the valve.

The valve bore closure member may engage with the body about an opening of the bore to close the bore when the diaphragm portion is in its initial, resiliently biased configuration.

The valve bore closure member may be compressible, the arrangement being such that the valve bore closure member is compressed when the diaphragm is in its initial configuration, at least part of the valve bore closure member being configured to elongate to accommodate said limited amount of movement of the diaphragm in the valve opening direction whilst part of the valve bore closure member remains in engagement with the body to close the opening of the valve bore.

The valve bore closure member may have body portion which projects from the diaphragm towards the bore and a head portion at a distal end of the body portion for engagement with the body to close the bore opening when the diaphragm is in its initial configuration, the elongate portion being formed as a bellows or concertina which is compressed when the diaphragm is in its initial configuration and which is configured to elongate as the diaphragm moves by said limited amount in the valve opening direction.

The valve bore closure member may have a body portion which projects from the diaphragm towards the bore and a head portion at a distal end of the body portion for engagement with the body to close the bore opening when the diaphragm is in its initial configuration, the head being formed as a flexible generally cup shaped member which is compressed when the diaphragm is in its initial configuration and which is configured to elongate as the diaphragm moves by said limited amount in the valve opening direction.

The valve may be configured so that movement of the diaphragm in the valve opening direction beyond said limited amount draws the valve bore closure member away from the body to enable fluid to pass through the bore from the valve inlet to the valve outlet.

The valve bore may be at least partly defined inside a tubular portion of the body and the valve bore closure member may engage around the outer surface of the tube to close the bore when the diaphragm is in its initial, resiliently biased configuration.

The diaphragm may be moved in the valve opening direction from its initial configuration towards the valve open configuration in response to fluid pressure acting on the valve member.

The valve inlet may direct fluid into the valve bore on the opposite side of the plunger seal means from the diaphragm, such that the fluid pressure acts on the distal end of the plunger in the valve bore.

The valve inlet may direct fluid into the valve between the valve bore closure portion and the diaphragm, so that the fluid pressure acts on the diaphragm.

The valve may be configured to open only when the fluid pressure acting on the valve member is at or above a predetermined minimum value.

Movement of the diaphragm in the valve opening direction within said limited amount may occur in response to an increase in the fluid pressure acting on the valve member but which is below the predetermined minimum value.

The valve may be configured so that the diaphragm moves beyond said limited amount of movement in the valve opening direction when the pressure of the fluid acting on the valve reaches the predetermined minimum value.

The diaphragm may be configured to move with an over-centre action to the valve open configuration when it moves beyond said limited amount of movement in the valve opening direction.

The diaphragm may be configured so that in use, it returns to its initial resiliently biased configuration to close the valve when the pressure of the fluid acting on the valve falls below the predetermined minimum value.

The plunger may be moved along the bore in the direction of flow of the fluid through the bore from the inlet to the outlet when the diaphragm returns to its initial, resiliently biased configuration to close the valve.

The diaphragm may be shaped generally like an inverted dome when in its initial configuration.

The diaphragm may be a rolling diaphragm.

The diaphragm may be generally dome shaped in its initial configuration, and may be moved towards the valve open position in response to a force applied to it by an actuation means.

Said limited amount of movement of the diaphragm in the valve opening direction may be predetermined.

Said limited amount of movement of the diaphragm in the valve opening direction may be in the range of 0.1 to 10 mm.

Said limited amount of movement of the diaphragm in the valve opening direction may be in the range of 0.3 to 3 mm.

In accordance with a second aspect of the invention, there is provided a fluid check valve comprising an inlet and an outlet and a bore in the flow path between the inlet and the outlet, the valve further comprising a valve member which is movable between a rest position, in which the valve member sealingly engages with the surface of the bore to prevent fluid moving between the inlet and the outlet, and an open position, in which a fluid path between the inlet and the outlet exists, the valve further comprising a resilient means for biasing the valve member towards the rest position, the valve member being movable along the bore from the rest position to the open position against the bias of the resilient means by the pressure of a fluid acting on the valve member.

In accordance with a third aspect of the invention, there is provided a fluid device comprising a body having first and second portions which are assembled together to define at least one fluid flow passage between them, said device further comprising a valve in accordance with the first or the second aspect of the invention for controlling the flow of a fluid through said at least one fluid passage.

The valve bore may defined in a first of the body portions and the valve member may be provided on the other of the body portions.

The valve member may be an integral part of the other of the body portions.

The other of the body portions may be formed from two or more plastics materials using bi-injection moulding techniques.

The body portions may have corresponding faces that oppose each other when they are assembled together, with the at least one fluid passage being defined between the opposing faces, and the longitudinal axis of the valve bore may be aligned generally perpendicular to the axis of the at least one fluid passage.

The valve bore may extend into the first of the body portions from its opposing face and a further bore may extend from an inner end region of the valve bore and open at the opposing face. The further bore may be an outlet passage of the valve or an inlet passage of the valve.

The device may be a pump-action fluid dispenser which may have a pump-chamber which can be compressed to pressurise a fluid in the chamber, in which case, the valve may be an outlet valve of the chamber or an inlet valve of the chamber.

The dispenser may have or be adapted to be mounted to a fluid container, and the valve may be an air inlet valve for the container.

The device may have an outlet nozzle and the valve may be a pre-compression outlet valve configured to enable fluid to enter the outlet nozzle only when it is at or above a predetermined minimum value. The nozzle may have an outlet orifice and the longitudinal axis of the valve bore may extend generally perpendicularly to the axis of the outlet orifice.

The device may have actuator which moves relative to the remainder of the dispenser in response to the application of a force by a user to actuate the dispenser pump. The may have an abutment means configured to contact the valve member diaphragm and move it in the valve opening direction when the actuator is moved by a user to actuate the dispenser pump. The actuator may be a trigger actuator.

Several embodiments of the invention will now be described, by way of example only, with reference to the accompanying drawings, wherein:

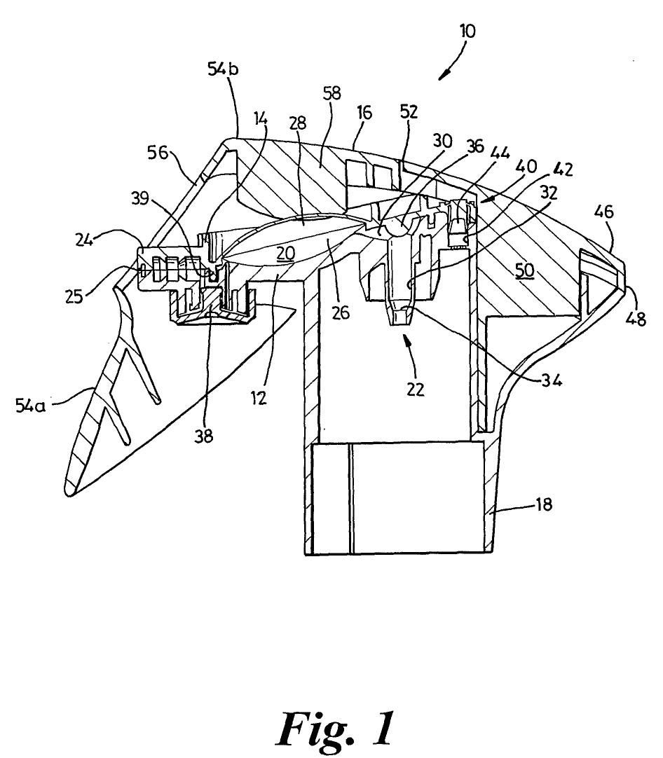

FIG. 1 is a cross sectional view through a first embodiment of a pump-action dispenser comprising a valve in accordance with the invention;

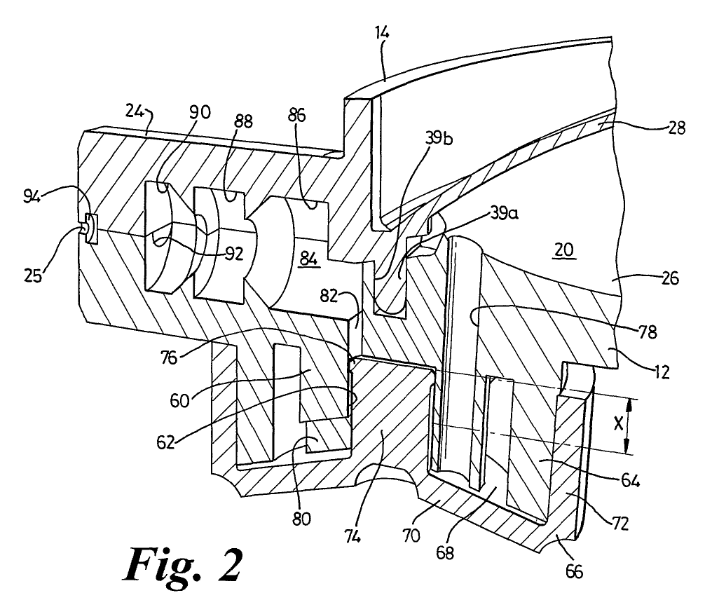

FIG. 2 is an enlarged view of part of the dispenser of FIG. 1, showing details of the valve between an outlet of the pump chamber and the nozzle;

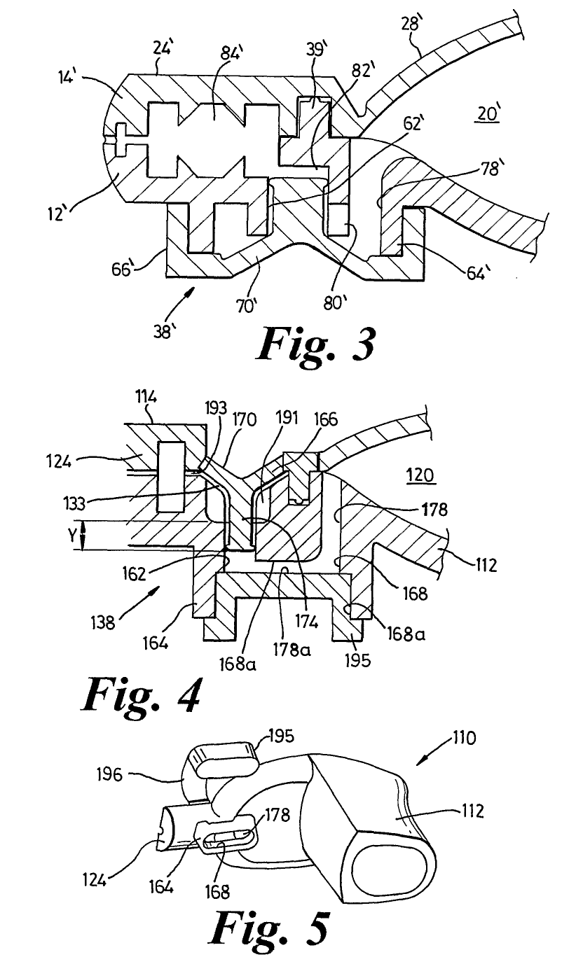

FIG. 3 is scrap, cross sectional view similar to that of FIG. 2 through part of a second embodiment of a dispenser comprising a valve in accordance with the invention;

FIG. 4 is scrap, cross sectional view similar to that of FIG. 2 through part of a third embodiment of a dispenser comprising a valve in accordance with the invention;

FIG. 5 is a perspective view from below of a lower body portion of the dispenser of FIG. 4;

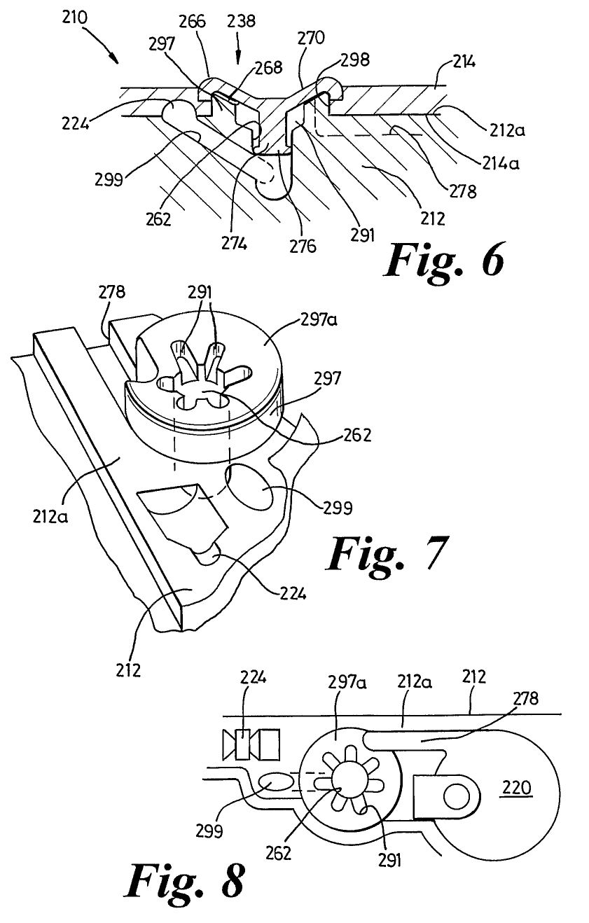

FIG. 6 is a scrap, cross sectional view similar to that of FIG. 2, through part of a fourth embodiment of a dispenser comprising a valve in accordance with the invention;

FIG. 7 is a perspective view of part of a lower body portion of the dispenser of FIG. 6;

FIG. 8 is a plan view of part of the lower body portion of FIG. 7;

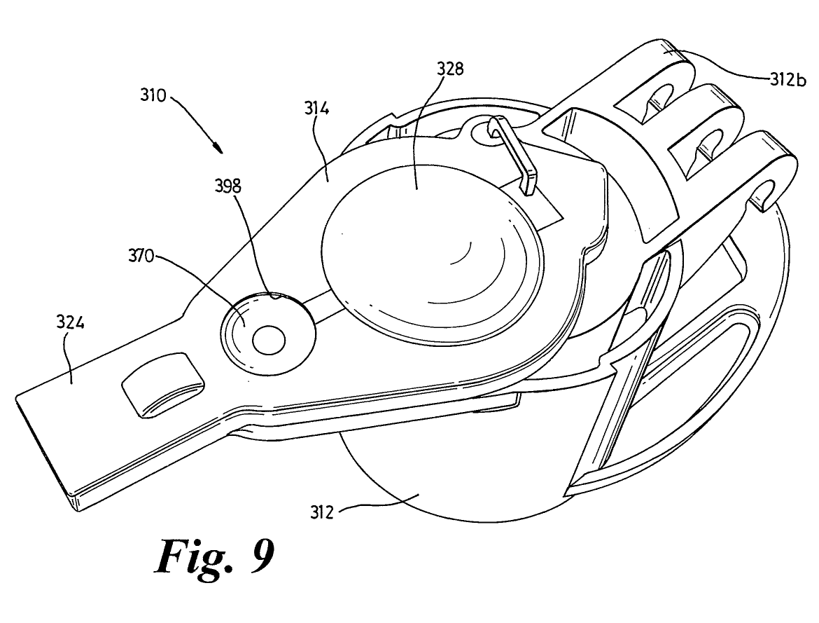

FIG. 9 is a perspective view from above a further embodiment of a dispenser having a valve in accordance with the invention;

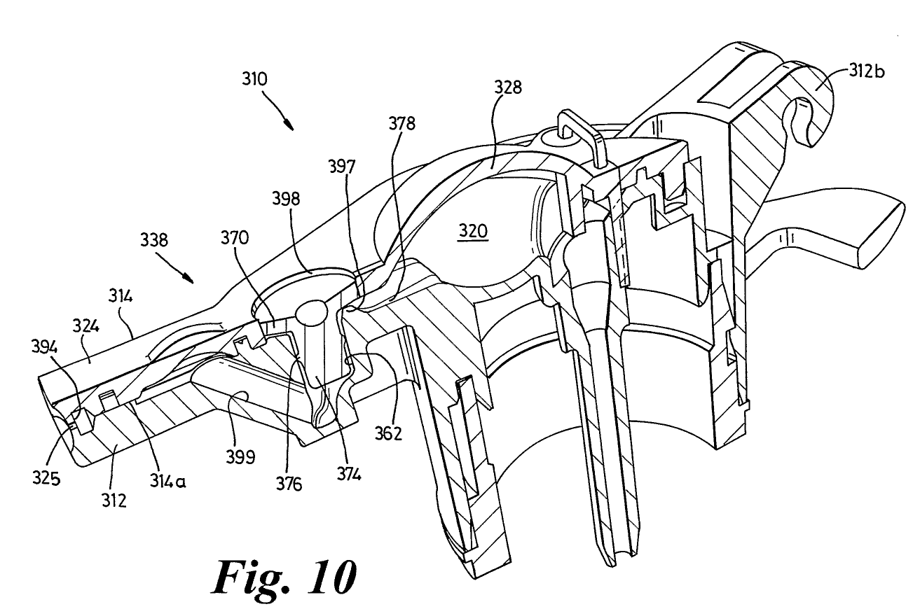

FIG. 10 is a perspective sectional view through the dispenser of FIG. 9;

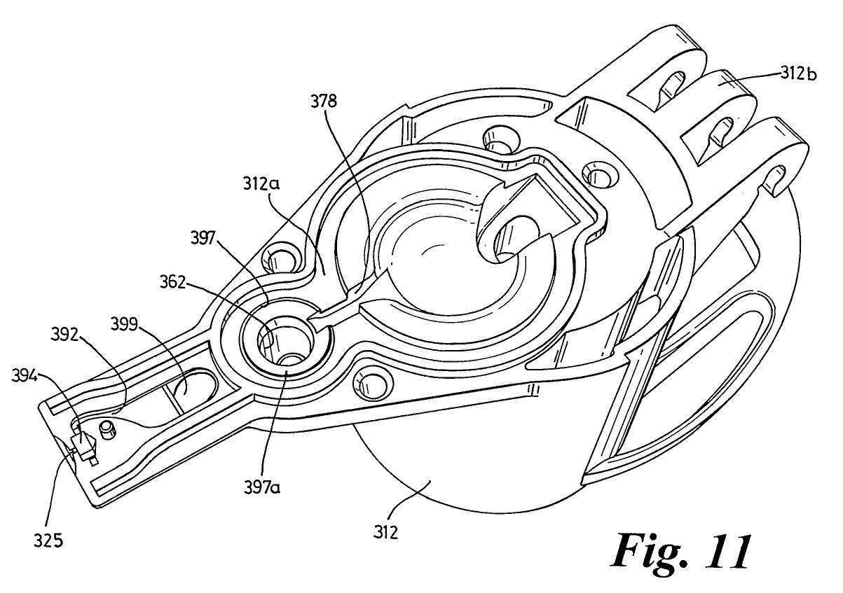

FIG. 11 is a perspective view from above of a lower body portion forming part of the dispenser of FIG. 9; and

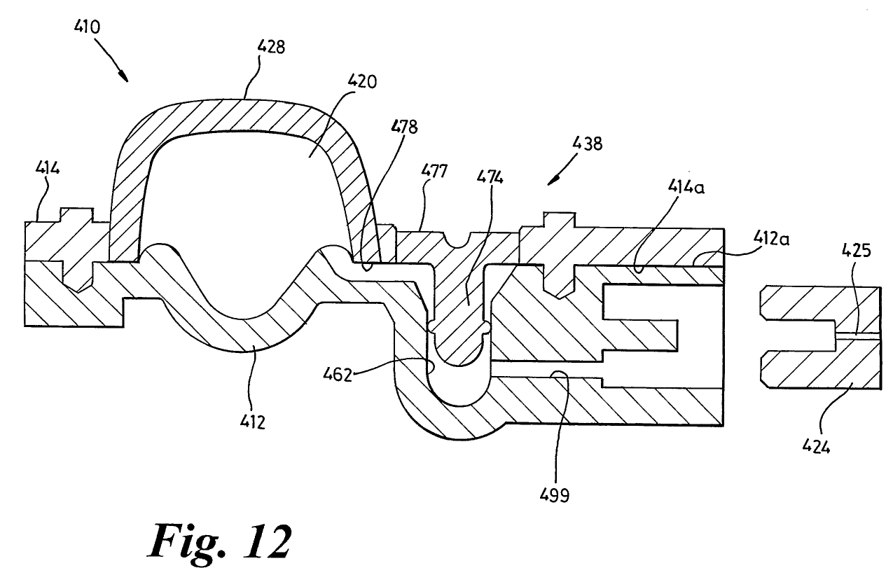

FIG. 12 is a schematic cross-sectional view through a further embodiment of a dispenser comprising a valve in accordance with the invention.

The same reference numbers but increased by 100 in each case are used to identify the same or corresponding features in each of the embodiments described.

FIGS. 1 and 2 show a trigger actuated pump-action dispenser 10. The dispenser 10 comprises a first, lower body portion 12, a second, upper body portion 14 and a third, actuator portion 16. All three portions are made from plastics materials and may be moulded as a single integral component in which the body portions are interconnected by flexible hinge means for later assembly.

The lower body portion 12 includes a neck 18 by means of which the dispenser can be mounted to a container (not shown) for fluid to be dispensed. In an alternative embodiment, the pump-action dispenser 10 can be formed integrally with a fluid container.

When assembled, as shown in FIGS. 1 and 2, the upper and lower body portions 12, 14 define between themselves a pump chamber 20, an inlet 22 to the pump chamber and an outlet from the pump chamber including an outlet nozzle 24 having an outlet orifice 25. The pump chamber 20 is formed between a rigid concave wall portion 26 of the lower body portion 12 and a flexible, resilient dome 28 which forms part of the upper body portion 14. The inlet 22 to the pump chamber includes a passageway 30 that interconnects the chamber with a bore 32 of a vertically arranged spigot 34 forming part of the lower body portion 12. In use, a flexible dip tube (not shown) will be located on the outside of the spigot 34 to extend into the container to enable the contents of the container to be drawn into the chamber. A one way valve 36 controls the movement of fluid from the container into the chamber. Movement of fluid from the pump chamber and into the outlet nozzle is controlled by means of a pre-compression valve 38 in accordance with the invention, as will be described in more detail below.

A seal 39 is formed between the upper body portion 14 and the lower body portion 12 about the pump chamber 20 to prevent fluid from leaking out of the pump chamber between the two body portions. The seal 39 comprises a projection 39a on the upper body portion that engages with a tight fit in a corresponding groove 39b in the lower body portion. Similar seal means may be provided about the features of the outlet nozzle 24. The upper and lower body portions 12, 14 may be welded together using any suitable method such as heat, ultra-sonic and laser welding. In particular, the body portions may be welded together along the line of the seal to ensure that the fluid does not seep between the two portions of the body.

An air inlet valve 40 allows air to be drawn into the container as the contents are used up. The air inlet valve comprises a passage 42 formed in the lower body portion 12 and which connects the interior of the neck 18 with atmosphere. A flexible inverted cup shaped valve member 44, which is formed as part of the upper body portion 14, locates in the passage. The lower edge of the valve member is resiliently biased into contact with the wall of the passage to form a seal. In the event that the pressure in the container falls below atmospheric by a predetermined amount, the flexible valve member will deform inwardly to admit air into the neck and so into the container to prevent the container from collapsing.

The third actuator body portion 16 has a rear mounting portion 46 that is attached to the lower body portion 12 by means of a flexible hinge 48. The mounting portion 46 also includes at least one spigot 50 that is received in a corresponding recess formed in the lower body portion when the mounting portion is in the assembled position as shown in FIG. 1.

Pivotably attached to the mounting portion 46 by means of a hinge 52 is a trigger portion 54. The trigger portion has a trigger 54a that extends below the outlet nozzle 24 with an opening 56 through which the nozzle projects. An abutment member or prodder 58 projects downwardly from the inner surface of an upper region 54b of the trigger portion so as to engage the outer surface of the flexible dome 28. When a user pulls the trigger 54a towards the neck 18 of the dispenser, the trigger portion pivots about the hinge 52 so that the prodder 58 contacts and compresses the flexible dome 28 to pressurise the contents of the chamber 20.

The outlet pre-compression valve 38 and the outlet nozzle 24 will now be described with reference in particular to FIG. 2.

The lower body portion 12 includes a first downwardly projecting annular member 60 that defines a bore 62 forming part of the pre-compression valve. A second, larger diameter downwardly projecting annular member 64 extends around the first annular member 62.

An inverted cup shaped valve member 66 is mounted about the second annular member 64 so as to define an inlet chamber 68 for the valve within the second annular member 64. The valve member is formed from a flexible, resilient plastics material and has a base or diaphragm portion 70 and an outer circular wall 72 connected to the outer edge of the base. The outer wall 72 of the valve member engages with the outer surface of the second annular member 64 with a tight fit so as to form an air tight seal. The valve member may be secured to the second annular member by welding or by bonding. A plunger or valve bore closure member 74 extends upwardly from the centre of the diaphragm portion 70 into the bore 62. The distal end of the plunger has a seal means 76 that engages with the surface of the bore to form an air tight seal. In the present embodiment, the seal means 76 comprises a region of increased diameter of the plunger 74 but a separate seal means could be mounted to the plunger.

A fluid passageway 78 extends through the first annular member 62 to fluidly connect the pump chamber 20 with the valve inlet chamber 68. A recess 80 is formed in a lower or outer end of the first annular member 62 at a region spaced from the fluid passageway 78 to provide an inlet into the valve bore 62 from the valve inlet chamber 68. The upper or inner end of the bore 62 is partially closed off but a fluid passage 82 fluidly connects the inner end of the bore with a chamber 84 forming part of the outlet nozzle 24 and comprises an outlet of the valve.

The valve member 66 is constructed so that in an initial, resiliently biased or rest position of the diaphragm 70, the plunger 74 is located in the bore 62 so that the distal end of the plunger is positioned adjacent the upper end of the bore. With the plunger in the rest position, the seal 76 engages the surface of the bore between the recess 80 and fluid passage 82 and so prevents fluid from passing between the inlet 80 and the outlet 82.

The valve is opened in response to an increase in the pressure of the fluid at the inlet side of the valve. Thus, when the dispenser is actuated, the pressure of the fluid in the pump chamber 20 increases and this increase in pressure is transmitted through the fluid in the passageway 78 to the fluid in the valve inlet chamber 68 where it acts on the inner surface of the diaphragm portion 70 of the valve member 66. In this respect, the diaphragm 70 acts as a pressure member to sense the increase in pressure at the inlet side of the valve relative to atmospheric pressure acting on the other side of the diaphragm portion. Once the pressure of the fluid, which will usually be a liquid such as a liquor, increases sufficiently, it overcomes the resilient bias of the valve member 66 and deflects the diaphragm portion 70 outwardly drawing the plunger 74 along the bore from the rest position towards an open position in which the seal means 76 passes over the recess 80 to create a fluid flow path across the valve from the inlet 80 to the outlet 82.

Once the fluid in the pump chamber 20 has been dispensed and the pressure acting on the inner surface of the diaphragm 70 of the valve member drops below the desired level at which the valve opens, the resilience of the valve member move the diaphragm 70 immediately back to its initial, resiliently biased position moving the plunger 74 back along the bore 62 to close the valve 38 quickly.

An important feature the inventive valve 38 is the movement X of the plunger 74 from the rest position to a position just prior to the seal means 76 uncovering the inlet recess 80, during which travel the valve remains closed. The ability of the valve member to move by at least a limited amount in response to an increase in pressure of the fluid at the inlet side of the valve without the valve opening can be used to accommodate the increasing pressure of the fluid in the pump chamber. This makes it easier to configure the valve so that it only opens once the fluid has reached the desired operating pressure. This arrangement can be contrasted with conventional pre-compression valves in which a valve member engages with a valve seat such that any movement of the valve member away from the valve seat results in at least a partial opening of the valve. With such conventional pre-compression valves, it can be difficult to ensure that the valve member only moves off the valve seat when the fluid acting on the valve member is at the desired operating pressure. This is particularly so for valves having components that are moulded from plastics materials and which are suitable for high volume production. The length of the bore X over which the seal 76 can move from its rest position whilst continuing to seal the bore can be considered a sealing region of the surface of the bore. By varying the length of the sealing region and the characteristics of the valve member, and in particular the diaphragm portion 70, the pressure at which the valve will open can be pre-determined for any particular fluid. The limited movement of the plunger and/or the diaphragm in an axial direction of the bore between the initial, resiliently biased position and the point at which the valve opens will often be in the range of 0.1 to 10 mm, and is more typically in the range of 0.3 to 3 mm. The pre-determined pressure at which the valve opens may be set at 0.5 Bar or more but will typically be 2 Bar or more.

A further advantage of the valve 38 in accordance with the invention is that the flow path created when the valve is open can be relatively large in comparison with prior art pre-compression valves. In the present embodiment, the valve inlet recess 80 is large and the valve member 66 can be arranged so that once the plunger 74 has been moved close to the open position and the pressure of the fluid in the valve inlet chamber reaches the desired operating value, the diaphragm portion 70 of the valve member moves outwardly in an over-centre type action so that the final opening of the valve takes place very quickly.

The outlet nozzle arrangement 24 essentially comprises a fluid outlet passage that connects the pre-compression valve 38 with the final outlet orifice 25. The nozzle arrangement 24 can take many different forms according to the needs of the particular application. The nozzle arrangement may, for example, include any of the flow control means disclosed in the applicant's International patent application published as WO 01/89958 A1, the content of which is incorporated in its entirety.

As shown in FIGS. 1 and 2, the nozzle arrangement 24 may include a shaped chamber 84 comprising three sections 86, 88, 90 interconnected in series. A fluid passage 92 leads from the final section 90 of the shaped chamber 84 to swirl chamber 94 adjacent the outlet orifice 25. The passage 92 feeds the fluid into the swirl chamber tangentially to cause the fluid to rotate within the swirl chamber before passing through the outlet orifice where it forms an atomised spray.

Where the nozzle 24 includes a shaped chamber 84, the chamber may be any of the shapes disclosed in the applicant's International patent application published as WO 2005/005055 A1, the entire content of which is hereby incorporated by reference. Thus, it should be understood that the shape of any of the fluid flow passage portions or chambers of the nozzle 24 in any of the embodiments described herein can be modified in accordance with the principles discussed in WO 2005/005055 A1.

Operation of the dispenser will now be described. For this purpose, it is assumed that the dispenser is mounted to a container containing a liquid to be dispensed and that the pump chamber 20, the passageway 78 between the pump chamber 20 and the valve inlet chamber 68, and the valve inlet chamber itself are all fully charged with the liquid.

To actuate the dispenser, a user pulls the trigger 54a towards the neck 18 of the dispenser causing the prodder 58 to contact and compress the flexible dome so pressurising the liquid in the pump chamber 20, the fluid passageway 78 and the inlet chamber 68 of the valve. At this stage, the one way inlet valve 36 to the pump chamber is closed preventing the liquid in the pump chamber 20 from exiting through the inlet. Continued squeezing of the trigger increases the pressure of the liquid in the inlet valve chamber 68 until the pressure is sufficient to deflect the diaphragm 70 of the valve member 66 outwardly to draw the plunger 74 along the bore so that the seal means 76 is moved closer to the inlet recess 80. When the liquid reaches a predetermined operating pressure, the diaphragm 70 of the valve member is deflected outwardly sufficiently that the seal means 76 is drawn past the recess 80 to create a flow path across the valve from the inlet 80 to the outlet 82.

Due to the incompressibility of the liquid, the flexible dome 28 will not have been deflected inwardly to any great extant up to the point at which the outlet pre-compression valve 38 opens. However, once the valve 38 has opened, continued squeezing of the trigger causes the actuation member 58 to deflect the flexible dome towards the rigid wall 26 of the pump chamber 20, forcing the liquid in the chamber to flow through passageway 78, the outlet valve 38, the outlet nozzle 24 and out of the final outlet orifice 25, from which it is dispensed as an atomised spray.

Once the flexible dome 28 as been fully depressed, the pressure of the liquid in the valve inlet chamber 68 will fall below the predetermined operating pressure and the resilience of the valve member 66 will move the plunger 74 back along the bore 62 to close the valve 38, with the plunger eventually moving back to its rest position as the diaphragm 70 returns to its initial, resiliently biased position. It will be noted that in the present embodiment, the plunger 74 moves towards the rest position in the direction of flow of the fluid through the valve from the inlet 80 to the outlet 82. Thus, as the valve closes, the movement of the plunger 74 assists in pushing any liquid in the bore 62 above the seal means 76 into and through the outlet nozzle 24. This helps to reduce spluttering towards the end of the delivery cycle. It is an important feature of the valve when used in a dispenser that the valve closes quickly at the end of the spray cycle to prevent any air from entering the pump chamber through the nozzle.

Following actuation, the user releases the trigger and the flexible dome 28, which is made of a resilient material, restores itself to its rest position, as shown in FIG. 1, in which chamber 20 has a maximum volume. As the outlet valve 38 is now closed, no liquid or air can be drawn into the pump chamber 20 through the outlet nozzle 24 and so the restoration of the flexible dome 28 creates a partial vacuum in the pump chamber 20. The partial vacuum in the pump chamber 20 draws a new charge of liquid into the pump chamber through the dip tube and the inlet valve 36 ready for a further actuation of the dispenser.

FIG. 3 shows a slightly modified arrangement of the outlet valve 38′ and outlet nozzle 24′. The valve 38′ as shown in FIG. 3 is similar to that in the previous embodiment except that the fluid passageway 78′ connecting the pump chamber 20 with the outlet valve inlet chamber 68′ is provided between the first, inner annular member 62′ and the second outer annular member 64′. The nozzle chamber 84′ is also of a different shape to the shaped chamber 84 in the previous embodiment. In other respects, dispenser 10′ is configured and operates in the same manner as in the dispenser 10 described above. In particular, the outlet pre-compression valve 38′ will operate in a manner similar to the valve 38 described above.

FIGS. 4 and 5 show a further embodiment of a dispenser 110 having a pre-compression valve 138 in accordance with the invention.

As with the first embodiment described above, the dispenser 110 has a first, lower body portion 112 and a second, upper body portion 114 that define between them a pump chamber 120 and an outlet nozzle 124. Depending downwardly (as shown) from the lower body portion is an elongate, annular wall member 164 within which is defined a recess 168 having a base 168a. A first bore 178 extends from the base of the recess to the interior of the pump chamber 120 to define a fluid passageway. A second bore 162, spaced from the first bore 178, extends from the base of the recess 168 through the lower body portion. An array of grooves or slots 191 are formed about the surface of an upper region of the second bore 162. The second bore 162 forms part of the outlet pre-compression valve 138 and the grooves or slots 191 provide a flow path across the valve to an inlet orifice 193 of the outlet nozzle 124 when the valve is open.

A valve member 166 is moulded integrally with the upper body portion and comprises a plunger portion 174 and a diaphragm portion 170. The arrangement is such that when the upper and lower body portions are assembled, as shown in FIG. 4, the plunger portion 174 locates in the valve bore 162 and the diaphragm portion 170 encloses a region above the upper end of the bore 162 and open upper ends of the grooves or slots 191 to define an enclosed valve outlet chamber 133. The diaphragm portion 170 is resilient so that in an initial, resiliently biased position it biases the plunger portion 174 into the valve bore 162 to a rest position as shown in FIG. 4, where the plunger portion seals with the solid sealing surface region of the lower portion of the bore 162. The inlet orifice 193 to the outlet nozzle arrangement 124 opens into the valve outlet chamber 133 defined between the diaphragm portion 170 and the lower body portion 112 so that fluid can pass from the valve outlet chamber 133 into the outlet nozzle 124. The end of the plunger portion 174 distal from the diaphragm portion 170 has a region of increased diameter which forms a seal for contact with the surface of the valve bore 162.

The recess 168 has a region of increased size 168a adjacent the distal lower end of the annular wall member 164. A bung 195 is received in the increased size region of the first recess to close the recess off and to define a fluid channel 178a for fluidly connecting the first bore 178 with the second valve bore 162. This arrangement enables the lower body portion to be produced from a plastics material by injection moulding. As shown in FIG. 5, the bung maybe attached to the remainder of the lower body portion 112 by means of a flexible hinge 196 in order that they can be moulded integrally as a single component for later assembly. The bung may be welded or heat crimped in position in the first recess 168a.

In operation, fluid, usually a liquid, will be present in the pump chamber, the first bore 178, the fluid channel 178a and the region of the valve bore 162 below the head of the plunger portion 174. When dispenser is actuated, the pressure of the fluid acting on the lower face of the plunger portion 174 increases and pushes the plunger portion along the bore 162, upwardly as shown, against the resilience of the diaphragm portion 170. Once the fluid reaches the required operating pressure, the plunger portion 174 is pushed into the upper region of the bore 162 enabling the fluid to pass through the grooves or slots 191, into the chamber 133 and through the inlet orifice 193 to the nozzle 124. The fluid then passes through the nozzle 124 to be dispensed in the usual manner. Once the pump chamber 120 has been fully collapsed, the pressure of the fluid acting on the lower face of the plunger portion 174 will drop below the operating pressure and the diaphragm portion 170 will bias the plunger portion 174 back into the lower, solid surface region of the valve bore 162 to close the valve.

As with the previous embodiments, the plunger portion 174 is able to move over a distance Y within the bore 162 before the valve is opened to accommodate the increasing pressure of the fluid in the pump chamber 120 and the inlet to the valve.

FIGS. 6 to 8 show a further embodiment of a dispenser 210 having a pre-compression valve 238 in accordance with the invention.

As with the previous embodiments described above, the dispenser 210 has a first, lower body portion 212 and a second, upper body portion 214 that define between them a pump chamber 220 and an outlet nozzle 224.

The lower body portion 212 has an abutment surface 212a which contacts a corresponding abutment surface 214a on the upper body portion 214 when the two body portions are assembled. The valve 238 includes a circular boss 297 which projects from the abutment surface 212a of the lower body portion 212 at a region between the pump chamber 220 and the outlet nozzle 224. The boss 297 is received in a corresponding circular opening 298 formed in the upper body portion 214 when the dispenser is assembled. The upper surface 297a of the boss is dished inwardly towards a central blind valve bore 262, which extends through the boss and into the main body of the lower body portion. An array of slots or channels 291 are formed about an upper region of the bore to provide flow path across the valve 238 when the valve is open as will be described in more detail later.

An angled bore 299 extends from the abutment surface 212a into an inner end region of the valve bore 262 to provide a fluid outlet passage between the valve bore 262 and the outlet nozzle 224. On the upstream side of the valve 238, a slot 278 is formed in the abutment surface 212a of the lower body portion from the pump chamber to the boss 297 and continues up one side of the boss 297. The slot 278 provides a fluid flow path connecting the pump chamber 220 to the upper surface 297a of the boss.

A valve member 266 is mounted to the upper body portion 214. The valve member comprises a diaphragm portion 270 and a plunger portion 274. The diaphragm portion 270 is mounted about the circular opening 298 in the upper body portion 214 so as to completely enclose the upper end of the boss 297 so that a fluid chamber 268 is formed between the valve member 266 and the boss 297. The plunger portion 274 extends into the valve bore 262 and has an enlarged diameter portion 276 at the end distal from the diaphragm portion which is arranged to engage and seal with the surface of the bore 262. The diaphragm portion 270 is resilient and the valve member is configured such that in an initial, resiliently biased position of the diaphragm, the plunger portion 274 is biased into the bore to a position in which the enlarged diameter portion 276 sealingly engages with a sealing region of the bore 262 between the inner end of the slots or channels 291 and the opening into the bore 262 of the outlet passage 299. In this position, the plunger portion 274 prevents fluid passing through the valve bore into the outlet passage 299.

In operation, prior to the dispenser being actuated, fluid (usually a liquid) will be present in the pump chamber 220, the inlet slot 278, the chamber 268 formed between the diaphragm portion 270 of the valve member and the upper surface 297a of the boss 297, the slots or side channels 291, and a region of the valve bore 262 above the enlarged diameter portion 276 of the plunger 274. When the dispenser is actuated, the pressure of the fluid in the pump chamber 220 will increase and this increase in pressure will be transferred to the fluid acting on the inner surface of the diaphragm portion 270 of the valve member 266. As the pressure of the fluid increases, it will tend to bias the diaphragm portion 270 outwardly against its resilient bias force so drawing the plunger portion 274 along the valve bore 262, in an upward direction as shown. The valve is configured such that once the fluid has reached the required operating pressure, the plunger 274 will have moved along the valve bore 262 to a position where the enlarged diameter portion 276 has uncovered the inner ends of the slots or side channels 291. The fluid is now able to pass through the slots or side channels 191 into the inner end of the valve bore 262 bore and along the outlet passage 299 to the outlet nozzle 224, from which it is dispensed. Once the pump chamber 220 has been fully compressed, the pressure of the fluid acting on the diaphragm portion 270 of the valve member will drop below the required operating pressure and the resilience of the diaphragm portion will bias the plunger portion 274 back along the valve bore 262 to again close the valve.

Where the dispenser is moulded from plastics material, the valve member 266 will typically be co-moulded integrally with the upper body portion 214 using bi-injection moulding techniques. The valve member 266 may be manufactured from a substantially rigid plastics material or a substantially flexible plastics material or from a combination of substantially rigid and flexible plastic materials. The outlet passage or bore 299 can be produced in the lower body portion 212 by means of a spring loaded hydraulically actuated core pin in the mould. However, any suitable method of manufacture, including the use of side action on the tool, can be used.

The overall arrangement of the valve 238 could be reversed with an inlet passage connecting the pump chamber 220 with the inner end of the valve bore 262 below the plunger and an outlet passage connecting the area 268 between the boss 297 and the diaphragm portion 270 of the valve member with the outlet nozzle 224. In a further alternative embodiment, the diaphragm portion 270 can be formed as a bellows or a rolling diaphragm.

FIGS. 9 to 11 show a further embodiment of a dispenser 310 having pump chamber outlet pre-compression valve 338 which is similar to that of the previous embodiment. The overall construction of the dispenser is similar to the first embodiment 10 described above with reference to FIG. 1.

The dispenser 310 comprises a lower body portion 312 and an upper body portion 314 which are assembled together to define between them a pump chamber 320, an outlet nozzle 324 and the pump chamber outlet pre-compression valve 338. The two body portions 312, 314 have abutment faces 312a, 314a which contact each other when the parts are assembled as shown in FIG. 10. Although not shown in the drawings, a trigger actuator member similar to the trigger 16 in the first embodiment is mounted to hinge members 312b on the lower body portion 312.

The pre-compression valve 338 comprises a vertical blind bore 362 which is formed in the lower body portion 312 and which has an axis that extends perpendicularly to the general plane of the abutment faces 312a, 314a of the body portions 312, 314 and to the axis if the fluid flow passage formed between the abutment faces. A small boss or lip 397 is formed about the upper surface of the bore and has a tapered, part-conical inner surface 397a which forms a tapered opening into the bore. A groove 378 in the lower body portion defines a fluid passage fluidly connecting the pump chamber 320 and the valve bore 362.

An angled bore 399 is formed in the lower body portion to fluidly connect the inner closed end of the valve bore 362 with the outlet nozzle 324. The outlet nozzle comprises an outlet orifice 325, a swirl chamber 394 and a fluid passage 392 which directs the fluid from the angled bore 399 tangentially into the swirl chamber. The outlet orifice, swirl chamber and fluid passage 392 are all defined by means of corresponding grooves and recess in the abutment faces of the body portions 312, 314.

A valve member 366 is formed as an integral part of the upper body portion 314. The valve member 366 comprises a flexibly resilient diaphragm portion 370 and a plunger 374 which projects from the centre of the diaphragm 370 to be received in the valve bore 362. The flexible diaphragm 370 is located in a circular recess 398 in a rigid portion of the upper body member 314 which aligns with the valve bore 362 when the body portions are assembled. The upper body member 314 is formed from plastics materials using bi-injection moulding techniques. Thus the rigid portion is moulded in a first shot from a rigid material. The flexible valve member 366 and a flexible dome 328, which forms part of the pump chamber 320, are then over moulded onto the rigid portion in a second shot from a relatively flexible material. The plunger has an enlarged portion 376 which, when the valve member is in its rest position, contacts the surface of the valve bore 362 to act as a seal and prevent fluid from passing through the valve bore 362 to the outlet nozzle 324.

The valve 338 operates in a manner similar to the previous embodiment. Thus, the diaphragm portion 370 of the valve member 366 is configured to resiliently bias the plunger into the valve bore 362 to close the valve. When the dispenser is actuated and the flexible dome 328 of the pump chamber is compressed, the pressure of the fluid in the pump chamber 320 and in the area beneath the diaphragm portion 370 of the valve member increases. The increased fluid pressure acts on the inner surface of the diaphragm to move it outwardly against its natural bias. The outward movement of the diaphragm draws the plunger 374 upwardly, as shown, along the valve bore 362.

Once the pressure of the fluid in the pump chamber reaches the desired operating pressure, the plunger is withdrawn out of the valve bore 362 sufficiently that the seal 376 moves into the tapered inlet of the valve bore to so that fluid is able to pass by the seal 376, through the bore 362 and the angled bore 399 to enter the fluid passages of the outlet nozzle 324 to be dispensed. As with previous embodiments, the diaphragm 370 can be arranged to snap outwardly in an over-centre type action when the pressure of the fluid is at the desired level to open the valve quickly. Once the fluid has been dispensed, the pressure acting on the inner surface of the diaphragm portion 370 will fall and once it drops below the desired level, the diaphragm will force the plunger 374 back into the bore to close the valve as it returns to its initial, resiliently biased position. Because the movement of the plunger 374 as the valve closes is in the same direction as the flow of fluid through the valve, the closing movement of the plunger pushes any remaining fluid in the bore through the angled passage 399 and the outlet nozzle 324. This provides a clean cut off of the flow through the nozzle and reduces jetting or spluttering and the end of the dispensing phase.

As shown in FIG. 10, the valve bore 362 may have a tapered portion into which the seal 376 on the plunger is drawn to open the valve rather than having side channels or slots as shown in FIGS. 4 and 6. In a further alternative, the valve bore 362 may have a region of increased diameter near one end into which the plunger is moved to open the valve or indeed the plunger could be arranged the leave the valve bore completely. In a yet further alternative, the inlet to the valve 338 may comprise an angled bore which enters the vertical valve bore 362 part way along. The arrangement is such that the plunger 374 moves in response to an increase in the fluid pressure to uncover the opening of the inlet bore into the valve bore 362 to open the valve.

In the majority of split-body type dispensers in which the dispenser body comprise two parts that are assembled together, such as those described above, the nozzle is formed between the opposing faces 312a, 314a of the two parts. As a result it is necessary to provide a fluid passage, such as the angled passage 399 to connect between the inner end of the valve bore 362 and the opposing face 312a of the lower body portion. The angled passage 399 can be provided at the outlet or downstream end of the valve bore as shown, or the valve arrangement could be reversed and the angled passage 399 provided at the inlet or upstream end. Angled passages into the bore could be used at both the inlet and the outlet if required.

In some split-type dispensers the nozzle is provided as a separate insert. Where this is the case, the nozzle could be positioned level with the outlet end of the valve bore so that an angled bore can be avoided. FIG. 12 illustrates a split-body type dispenser 410 in which the nozzle 424 is proved as an insert which locates in a recess the lower body portion 412. In this arrangement, the outlet passage 499 which leads to the nozzle from the inner end of the valve bore 462 can be formed by a bore which extends parallel to the plane of the abutment face 412a of the lower body portion. This simplifies the moulding process, although it will still be necessary to use a movable pin in the mould to form the passage.

The plunger 74, 174, 274, 374 can be of any suitable shape provided it forms a suitable seal in the valve bore. For example, the free end of the plunger may be bell shaped, like the air release valve member 36 in the first embodiment—see FIG. 1. The plunger may also be hollow or at least partially hollow to make it easier and faster to mould. For example, the plunger may be partially hollowed out from above as shown in FIG. 10. The plunger and bore arrangement could also be reversed. The arrangement would be similar to that shown in FIG. 10 except that the bore 362 is provided at least partly inside a tube (not shown) projecting from the abutment surface 312a of the lower body portion and the plunger or valve closure member 374 has an annular portion (not shown) which engages around the outside of the tube. When the diaphragm 370 is in its initial configuration, the annular portion of the plunger engages the outer surface of the tube to form a seal and prevent fluid flowing into the bore. As the pressure of the fluid acting on the diaphragm increases, the annular portion is drawn along the tube until it exposes an end of a groove in the outer surface of the tube or a fluid passage that passes through the wall of the tube into the bore to open a fluid passage through the valve.

In a further alternative arrangement (not shown), the plunger or valve bore closure member may not engage inside the bore by may be partially squashed or compressed to close one end of the valve bore. The valve could be constructed in the a similar manner to the valve 338 shown in FIGS. 9 to 11, except that the plunger 374 contacts the surface 312a or the boss 397 to seal the inlet to the vertical valve bore 362 rather than entering the bore 362 itself. The arrangement is such that as the flexible diaphragm 370 moves outwardly in response to the increasing pressure of the fluid, part or all of the plunger stretches out or elongates whilst at least part of the plunger remains in contact with the surface 312a or the boss 397 to seal the bore. This movement continues until the plunger 374 reaches a limit at which it can stretch no further and is pulled clear of the bore opening to open the valve. This type of valve arrangement has similar benefits to the embodiments described above, in that the valve member is able to move as the pressure of the fluid increases to a limited extent without opening the valve until the desired operating pressure of the fluid is achieved, at which point the valve is opened quickly. This arrangement has the further advantage that there is no friction between the plunger and the bore. The plunger in this case may have a pleated or concertinaed main stem which acts like a bellows and a head which seals the opening to the valve bore 362. Alternatively, the head may be shaped like a sink plunger with a bell-shaped end that collapses once it has contacted the abutment surface 312a about the opening to the valve bore 362. The valve closure member 374 could be in the form of a flap valve rather than a plunger in this case.

The valve member diaphragm 70, 170, 270, 370, 470, in any of the embodiments can be of any suitable shape. The diaphragm may be a resilient dome such as that used in the embodiments described above and which is initially inverted to bias the plunger into the valve bore. Alternatively, the diaphragm may be flat and stretched out. The diaphragm could also be in the form of a rolling diaphragm or any other shape provided that it biases the valve plunger to close the valve in its initial, resiliently biased configuration and is able to move in response to an increase in the fluid pressure so that the valve can open.

In all the embodiments described above, it is the fluid pressure acting directly on the plunger itself or on the flexible diaphragm to which the plunger is mounted that causes the valve to open. However, the valve could be modified so that it is opened by an actuator. For example, in a dispenser such as that shown in FIGS. 9 to 11, the flexible diaphragm could be formed as a convex dome shaped member. The dispenser would normally have a trigger actuator or the like which lies over the top of the dispenser body. The trigger has an abutment member or prodder which contacts the dome forming part of the pump chamber when the trigger is pulled so as to compress the pump 328 chamber. In this modified valve arrangement, the trigger would have a further abutment member or prodder which contacts the valve dome 370 when the trigger is pulled to move the plunger 374 along the valve bore 362 until the valve is opened. The valve can be opened by moving the plunger so that it uncovers an outlet passage or is moved out of an end of the bore 362 into an expanded chamber which is connected with an outlet passage, for example. The dispenser arrangement would be configured so that at the point at which the outlet valve is opened; the actuator trigger has compressed the pump chamber 320 sufficient that the fluid is at the required operating pressure. Where the plunger or valve bore closure member closes the opening to the valve bore rather than locating inside the bore, the prodder can be arranged to distort of deflect the valve bore closure member over to one side to open the bore. Here again, it can be arranged that the diaphragm must be moved in the valve opening direction by a limited amount before the valve opens. Patent protection for this arrangement may be sought independently from the presently claimed invention.

In the embodiments disclosed herein, the inventive valve acts as an outlet valve to a pump chamber. However, valves in accordance with the invention can also be configured to act as an inlet valve to a pump chamber. To achieve this, one side of the valve member would be subject to the pressure in the pump chamber and the other side would be subjected to the pressure of the fluid in the container or other fluid source. Thus, as the pump chamber expands following actuation of the dispenser, a partial vacuum is created in the pump chamber which will be felt on the pump chamber side of the valve member. As a result, the relatively higher pressure of the fluid in container acting on the other side of the valve member moves the valve member from the rest position to the open position to enable the fluid to enter the pump chamber. Valves in accordance with the invention can also be used as an air inlet valve such as the valve 40 described above in relation to the first embodiment.

It should also be understood that valves in accordance with the invention are not limited for use in fluid dispensers of the type disclosed but can be configured for use in any suitable dispenser including trigger actuated dispensers and sprayers and all forms of manually actuated dispensers. Valves in accordance with the invention can used in dispensers regardless of the type of fluid to be dispensed. For example, they can be used in dispensers where the fluid to be dispensed is a liquid, liquor, gas (including air) and in dual dispensers that are configured to dispense two liquids, two gases or a mixture of liquids and gases. In particular, it should be understood that valves in accordance with the invention are not limited to use in dispensers that produce an atomised spray but can also be used in dispenser that produce a bolus of liquid or a foam.

Furthermore, valves in accordance with the invention are not limited to use in pump action dispensers but can be used in any suitable application where there is a need to control the flow of a fluid and, in particular, where there is a need to provide a low cost and efficient one way check valve. Valves in accordance with the invention are particularly suitable for use with any split-body type fluid device.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention.

Where the terms “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

1. A valve having a body, a fluid inlet, a fluid outlet and a bore defined in the body and which forms at least part of a fluid passage from the inlet to the outlet, the valve further comprising a movable valve member having a resiliently flexible diaphragm portion and a valve bore closure portion mounted to the diaphragm for movement therewith, the flexible diaphragm portion being movable in a valve opening direction from an initial resiliently biased configuration, in which the valve bore closure portion closes the bore to prevent fluid flowing through the bore from the inlet to the outlet, to a valve open configuration in which the valve bore closure portion does not close the bore and a fluid flow path through the bore from the inlet to the outlet is established, characterised in that valve is configured such that the diaphragm is able to move in the valve opening direction from its initial resiliently biased configuration towards its valve open configuration by a limited amount during which range of movement the valve bore is closed by the valve bore closure portion.

2. A valve as claimed in claim 1, in which the valve bore closure member comprises a plunger having seal means for engaging with a sealing region of the inner surface of the bore to form a seal preventing fluid from flowing through the bore from the inlet to the outlet when the diaphragm is in its initial configuration

3. A valve as claimed in claim 2, in which the plunger has main body portion with a diameter smaller than that of the valve bore and the seal means is mounted to the main body portion.

4. A valve as claimed in claim 2, in which the plunger has main body portion with a diameter smaller than that of the valve bore and the seal means comprises an enlarged diameter portion the plunger.

5. A valve as claimed in any one of claims 2 to 4, in which the sealing region of the surface of the bore extends over a predetermined length of the bore and the valve is configured so that plunger moves along the bore with the seal means in engagement with the sealing region as the diaphragm moves by said limited amount in the valve opening direction.

6. A valve as claimed in claim 5, in which movement of the diaphragm beyond said limited amount moves the seal means off the sealing region of the surface of the bore to open a flow path through the bore from the inlet to the outlet.

7. A valve as claimed in claim 6, the valve being configured so that the plunger seal is withdrawn from the bore when the diaphragm moves in the valve opening direction beyond said limited amount to open the flow path.

8. A valve as claimed in claim 6, the bore having an enlarged diameter portion, the valve being configured so that movement of the diaphragm beyond said limited amount in the valve opening direction moves the plunger seal means into the enlarged diameter portion to open the flow path.

9. A valve as claimed in claim 6, in which at least one groove or slot is provided in the surface of bore at one end thereof adjacent the sealing region, an outermost end of the at least one groove or slot being in fluid connection with one of the valve inlet and the valve outlet, the arrangement being such that movement of the diaphragm beyond said limited amount in the valve opening direction moves the plunger seal means off the sealing region and over the at least one groove or slot to open a fluid flow path through the valve from the inlet to the outlet.

10. A valve as claimed in claim 6, in which one of a fluid inlet passage and a fluid outlet passage opens into the valve bore at a position part way along the valve bore adjacent the sealing region, the arrangement being such that movement of the diaphragm beyond said limited amount in the valve opening direction moves the plunger seal means over the opening of said one of the inlet fluid passage and the fluid outlet passage to open the fluid flow path across the valve.

11. A valve as claimed in claim 1, in which the valve bore closure member engages with the body about an opening of the bore to close the bore when the diaphragm portion is in its initial, resiliently biased configuration.

12. A valve as claimed in claim 11, in which the valve bore closure member is compressible, the arrangement being such that the valve bore closure member is compressed when the diaphragm is in its initial configuration, at least part of the valve bore closure member being configured to elongate to accommodate said limited amount of movement of the diaphragm in the valve opening direction whilst part of the valve bore closure member remains in engagement with the body to close the opening of the valve bore.

13. A valve as claimed in claim 12, in which the valve bore closure member comprises body portion which projects from the diaphragm towards the bore and a head portion at a distal end of the body portion for engagement with the body to close the bore opening when the diaphragm is in its initial configuration, the elongate portion being formed as a bellows or concertina which is compressed when the diaphragm is in its initial configuration and which is configured to elongate as the diaphragm moves by said limited amount in the valve opening direction.

14. A valve as claimed in claim 12, in which the valve bore closure member comprises body portion which projects from the diaphragm towards the bore and a head portion at a distal end of the body portion for engagement with the body to close the bore opening when the diaphragm is in its initial configuration, the head being formed as a flexible generally cup shaped member which is compressed when the diaphragm is in its initial configuration and which is configured to elongate as the diaphragm moves by said limited amount in the valve opening direction.

15. A valve as claimed in any one of claims 11 to 14, in which the valve is configured so that movement of the diaphragm in the valve opening direction beyond said limited amount draws the valve bore closure member away from the body to enable fluid to pass through the bore from the valve inlet to the valve outlet.

16. A valve as claimed in claim 1, in which the valve bore is at least partly defined inside a tubular portion of the body and the valve bore closure member engages around the outer surface of the tube to close the bore when the diaphragm is in its initial, resiliently biased configuration.

17. A valve as claimed in any one of the preceding claims, in which the diaphragm is moved in the valve opening direction from its initial configuration towards the valve open configuration in response to fluid pressure acting on the valve member.

18. A valve as claimed in claim 17, when dependent on any one of claims 2 to 10, in which the valve inlet means directs fluid into the valve bore on the opposite side of the plunger seal means from the diaphragm, such that the fluid pressure acts on the distal end of the plunger in the valve bore.

19. A valve as claimed in claim 17, in which the valve inlet means directs fluid into the valve between the valve bore closure portion and the diaphragm, so that the fluid pressure acts on the diaphragm.

20. A valve as claimed in claim 18 or claim 19, in which the valve is configured to open only when the fluid pressure acting on the valve member is at or above a predetermined minimum value.

21. A valve as claimed in claim 20, in which movement of the diaphragm in the valve opening direction within said limited amount occurs in response to an increase in the fluid pressure acting on the valve member but which is below the predetermined minimum value.

22. A valve as claimed in claim 20 and claim 21, in which the valve is configured so that the diaphragm moves beyond said limited amount of movement in the valve opening direction when the pressure of the fluid acting on the valve reaches the predetermined minimum value.

23. A valve as claimed in any one of claims 20 to 22, in which the diaphragm is configured to move with an over-centre action to the valve open configuration when it moves beyond said limited amount of movement in the valve opening direction.

24. A valve as claimed in any one of claims 20 to 23, in which the diaphragm is configure to return to its initial resiliently biased configuration to close the valve when the pressure of the fluid acting on the valve falls below the predetermined minimum value.

25. A valve as claimed in claim 24 when dependent on any one of claims 2 to 10, in which the plunger is moved along the bore in the direction of flow of the fluid through the bore from the inlet to the outlet when the diaphragm returns to its initial, resiliently biased configuration to close the valve.

26. A valve as acclaimed in any one of the preceding claims in which the diaphragm is shaped generally like an inverted dome when in its initial configuration.

27. A valve as claimed in any one of claims 1 to 25, in which the diaphragm is a rolling diaphragm.

28. A valve as claimed in any one of claims 1 to 16, in which the diaphragm is generally dome shaped in its initial configuration, and is moved towards the valve open position in response to a force applied to it by an actuation means.

29. A valve as claimed in any one of the preceding claims, in which said limited amount of movement is predetermined to ensure the valve opens only when the fluid is at or above a desired pressure.

30. A valve as claimed in any one of the preceding claims, in which said limited amount of movement is in the range of 0.1 to 10 mm.

31. A valve as claimed in any one of the preceding claims, in which said limited amount of movement is in the range of 0.3 to 3 mm.

32. A fluid check valve comprising an inlet and an outlet and a bore in the flow path between the inlet and the outlet, the valve further comprising a valve member which is movable between a rest position, in which the valve member sealingly engages with the surface of the bore to prevent fluid moving between the inlet and the outlet, and an open position, in which a fluid path between the inlet and the outlet exists, the valve further comprising a resilient means for biasing the valve member towards the rest position, the valve member being movable along the bore from the rest position to the open position against the bias of the resilient means by the pressure of a fluid acting on the valve member.

33. A fluid device comprising a body having first and second portions which are assembled together to define at least one fluid flow passage between them, said device further comprising a valve as claimed in any one of claims 1 to 31 for controlling the flow of a fluid through said at least one fluid passage.

34. A device as claimed in claim 33, in which the valve bore is defined in a first of the body portions and the valve member is provided on the other of the body portions.

35. A device as claimed in claim 34, in which the valve member is an integral part of the other of the body portions.

36. A device as claimed in claim 35, in which the other of the body portions is formed from two or more plastics materials using bi-injection moulding techniques.

37. A device as claimed in any one of claims 33 to 36, the body portions having corresponding faces that oppose each other when they are assembled together, with the at least one fluid passage being defined between the opposing faces, in which the longitudinal axis of the valve bore is aligned generally perpendicular to the axis of the at least one fluid passage.

38. A device as claimed in claim 37, in which the valve bore extends into the first of the body portions from its opposing face and a further bore extends from an inner end region of the valve bore and opens at the opposing face.

39. A device as claimed in claim 38, in which the further bore comprises an outlet passage of the valve.

40. A device as claimed in claim 39, in which the further bore comprises an inlet passage of the valve.

41. A device as claimed in any one of claims 33 to 40, in which the device is a pump-action fluid dispenser.

42. A device as claimed in claim 41, in which the dispenser comprises a pump-chamber which can be compressed to pressurise a fluid in the chamber and the valve comprises an outlet valve of chamber.

43. A device as claimed in claim 41, in which the dispenser comprises a pump-chamber which can be compressed to pressurise a fluid in the chamber and the valve comprises an inlet valve of chamber.

44. A device as claimed in claim 41, in which the dispenser comprises or is adapted to be mounted to, a fluid container, and the valve comprise an air inlet valve for the container.

45. A device as claimed in claim 42, in which the device comprises an outlet nozzle and the valve is a pre-compression outlet valve configured to enable fluid to enter the outlet nozzle only when it is at or above a predetermined minimum value.

46. A device as claimed in claim 45, in which the nozzle has an outlet orifice and the longitudinal axis of the valve bore extends generally perpendicularly to the axis of the outlet orifice.

47. A device as claimed in any one of claims 41 to 46, in which the device further comprises an actuator which moves relative to the remainder of the dispenser in response to the application of a force by a user to actuate the dispenser pump.

48. A device as claimed in claim 47, when dependent on claim 29, in which, the actuator has an abutment means configured to contact the valve member diaphragm and move it in the valve opening direction when the actuator is moved by a user to actuate the dispenser pump.

49. A device as claimed in claim 47 or claim 48, in which the actuator comprises a trigger actuator.

50. A device substantially as hereinbefore described, with reference to and as shown in FIGS. 1 and 2, or FIG. 3, or FIGS. 4 and 5, or FIGS. 6 to 8, or FIGS. 9 to 11, or FIG. 12 of the accompanying drawings.
